(19) United States
(12) Patent Application Publication
(10) Pub. No.: US 2002/0013938 A1
(43) Pub. Date: Jan. 31, 2002

(54) Fast runtime scheme for removing dead code across linked fragments

(76) Inventors: Evelyn Duesterwald, Somerville, MA (US); Vasanth Bala, Sudbury, MA (US); Sanjeev Banerjia, Cambridge, MA (US)

Correspondence Address: HEWLETT-PACKARD COMPANY, Intellectual Property Administration, P. O. Box 272400, Fort Collins, CO, 80527-2400, US

(21) Appl. No.: 09/755,381

(22) Filed: Jan. 5, 2001

Related U.S. Application Data
(60) Provisional application No. 60/184,624, filed on Feb. 9, 2000.

(51) Int. Cl. G06F 9/45

(52) U.S. Cl. 717/9

(57) ABSTRACT

A link-time optimization scheme is capable of removing from dead code from code fragments in a program which arise after the linking of code fragments. The scheme may be applied runtime to fragments which are linked in a caching dynamic translator or applied when linking fragments subsequent to the compilation of object code. The removal of dead code may be facilitated by the use of epilogs corresponding to exits from a fragment and prologs corresponding to entries into a fragment.

### RELATED APPLICATIONS

This application claims priority to provisional U.S. application Ser. No. 60/184,624, filed on Feb. 9, 2000, the content of which is incorporated herein in its entirety.

### FIELD OF THE INVENTION

The present invention relates generally to link time optimization, and more particularly to a system and method for removing dead code determined when linking across code fragments.

### BACKGROUND OF THE INVENTION

In a series of instructions, an instruction is called dead if it writes to a register and the register is re-assigned without being read prior to the next exit. Similarly, an instruction is called live if it assigns a register that is read subsequently. To optimize a series of instructions, it is possible to remove dead instructions.

Traditional dead code removal algorithms are applied during the compilation of a program, that is, on some intermediate format of the code, and they require extensive semantic analyses about the definitions and uses in a program. When applied during compilation, dead code removal is only performed separately within each compilation unit. To exploit dead code removal opportunities that arise across individual compilation units, dead code removal must be applied at link-time, that is, when the individual compilation units are linked together to form the fmal complete binary. We refer to this kind of dead code removal as link-time dead code removal. The linking of individual code fragments can occur in several scenarios. Linking of individually compiled code units may occur statically, immediately after compilation. Linking may also happen dynamically either prior to execution when the code is loaded (i.e., at loadtime) or during execution in an on-demand fashion. We focus in this invention on the latter sense of link-time dead code removal. This invention considers the linking of individually generated code fragments in a caching dynamic translation.

Common to all forms of link-time dead code removal is the fact that they have to be applied after code generation, that is on object code rather than some higher level intermediate code format. As a result, the data flow information about uses and definitions of variables that was gathered earlier during compilation on the intermediate form does not directly apply to the final object code and is there not useful.

Previously, link-time optimizations have been applied statically after compilation and prior to execution. Previous link-time optimizations include peephole optimizations, register re-allocation, and code reordering to avoid pipeline stalls or cache misses. Since data flow information has to be computed from scratch for the object code, previous link-time optimization techniques are typically heavyweight; code regions or entire link units are decoded, analyzed, and rewritten. The resulting overheads are tolerable if linking occurs statically prior to runtime. However, if linking occurs dynamically at runtime, such as in a dynamic caching translator, the overhead of any heavyweight optimization is likely to be prohibitive.

### SUMMARY OF THE INVENTION

According to the present invention, dead code can be identified and removed by processing code fragments and storing information generated during the processing of each of the code fragments, and, at a time when code fragments are to be linked, determining, by use of the stored information associated with the linked code fragments, if an instruction in the first code fragment that assigns a register is a dead instruction, and responsive to determination that an instruction is a dead instruction, eliminating the dead instruction.

In a further aspect of the invention, the stored information includes information that is stored in an epilog associated with each exit from a code fragment and information that is stored in a prolog associated with each entry to a code fragment.

In another aspect of the invention a pointer to each instruction for assigning a register that is possibly live for the identified exit is stored in an epilog for the first fragment. In yet another aspect of the invention, a first register mask in the epilog is generated, the first register mask having a plurality of positions, each position corresponding to a respective register, wherein a bit at a position is set if the respective register is assigned in an instruction pointed to by a pointer in the epilog.

In another aspect of the invention a second register mask for the second fragment is generated, the second register mask having a plurality of positions, each position corresponding to a respective register, wherein a bit at a position is set if the respective register is assigned in the second fragment before being read.

### BRIEF DESCRIPTION OF THE DRAWINGS

FIG. 1 shows a block diagram of a dynamic translator consistent with the present invention;

FIG. 2A shows a diagram linking a first fragment to a second fragment;

FIG. 2B shows a diagram for transforming a first fragment;

FIG. 3 is a flow diagram of a process for removing dead code from a fragment consistent with the present invention;

FIGS. 4A and 4B are diagrams of an exemplary epilog and prolog, respectively;

FIG. 5 is a flow diagram for generating an epilog consistent with the present invention;

FIG. 6 is a flow diagram for generating a prolog consistent with the present invention; and

FIG. 7 is a flow diagram for removing dead code from a fragment using an epilog and a prolog consistent with the present invention.

### DETAILED DESCRIPTION OF THE PREFERRED EMBODIMENT

Consistent with the present invention, dead code within a fragment may be removed. Fragments are single-entry multi-exit dynamic sequences of blocks, where a block is a branch-free sequence of code. The dead code may be identified during the linking of fragments. The removal of dead code may be done, for example, during the linking of code fragments after compilation of object code or during the linking of code fragments in a caching dynamic translator at runtime.

Caching dynamic translators attempt to identify program hot spots (frequently executed portions of the program, such as certain loops) at runtime and use a code cache to store translations of those frequently executed portions. Subsequent execution of those portions can use the cached translations, thereby reducing the overhead of executing those portions of the program. These frequently executed portions are fragments, i.e., single-entry multi-exit sequences of blocks.

To identify fragments and store them in a code cache, the caching dynamic translator uses traces. Traces may pass through several procedure bodies, and may even contain entire procedure bodies. Traces offer a fairly large optimization scope while still having simple control flow, which makes optimizing them much easier than a procedure. Simple control flow also allows a fast optimizer implementation. A dynamic trace can even go past several procedure calls and returns, including dynamically linked libraries (DLLs). This allows an optimizer to perform inlining, which is an optimization that removes redundant call and return branches, which can improve performance substantially.

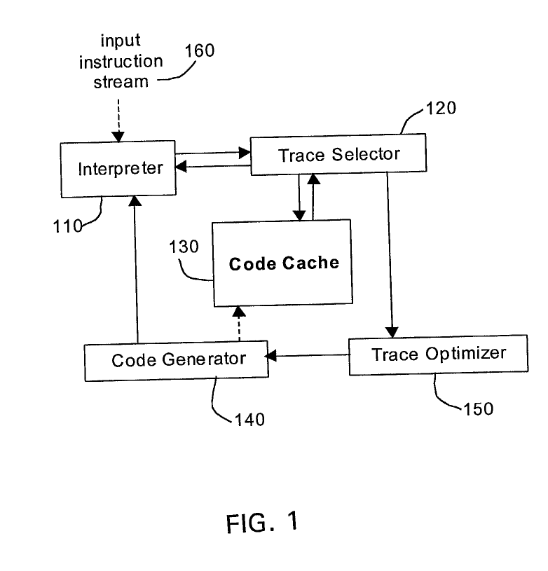

Referring to FIG. 1, a dynamic translator includes an interpreter 110 that receives an input instruction stream 160. This “interpreter” represents the instruction evaluation engine; it can be implemented in a number of ways (e.g., as a software fetch-decode-eval loop, a just-in-time compiler, or even a hardware CPU).

In one implementation, the instructions of the input instruction stream 160 are in the same instruction set as that of the machine on which the translator is running (native-to-native translation). In the native-to-native case, the primary advantage obtained by the translator flows from the dynamic optimization 150 that the translator can perform. In another implementation, the input instructions are in a different instruction set than the native instructions.

The trace selector 120 identifies instruction traces to be stored in the code cache 130. The trace selector is the component responsible for associating counters with interpreted program addresses, determining when to switch between the interpreter states (between normal and trace growing mode), and determining when a “hot trace” has been detected.

Much of the work of the dynamic translator occurs in an interpreter-trace selector loop. After the interpreter 110 interprets a block of instructions (i.e., until a branch), control is passed to the trace selector 120 to make the observations of the program's behavior so that it can select traces for special processing and placement in the cache. The interpreter-trace selector loop is executed until one of the following conditions is met: (a) a cache hit occurs, in which case control jumps into the code cache, or (b) a hot start-of-trace is reached.

When a hot start-of-trace is found, the trace selector 120 switches the state of the interpreter 110 so that the interpreter emits the trace instructions until the corresponding end-of-trace condition (condition (b)) is met. A start-of-trace condition may be, for example, a backward taken branch, procedure call instructions, exits from the code cache, system call instructions, or machine instruction cache misses. An end-of-trace condition may be, for example, when a certain number of branch instructions have been interpreted since entering the grow trace mode, a backward taken branch is interpreted, or a certain number of native translated instructions has been emitted into the code cache for the current trace.

After emitting the trace instructions, the trace selector 120 invokes the trace optimizer 150. The trace optimizer 150 is responsible for optimizing the trace instructions for better performance on the underlying processor. After optimization is completed, the code generator 140 emits the trace code into the code cache 130 and returns to the trace selector 120 to resume the interpreter-trace selector loop.

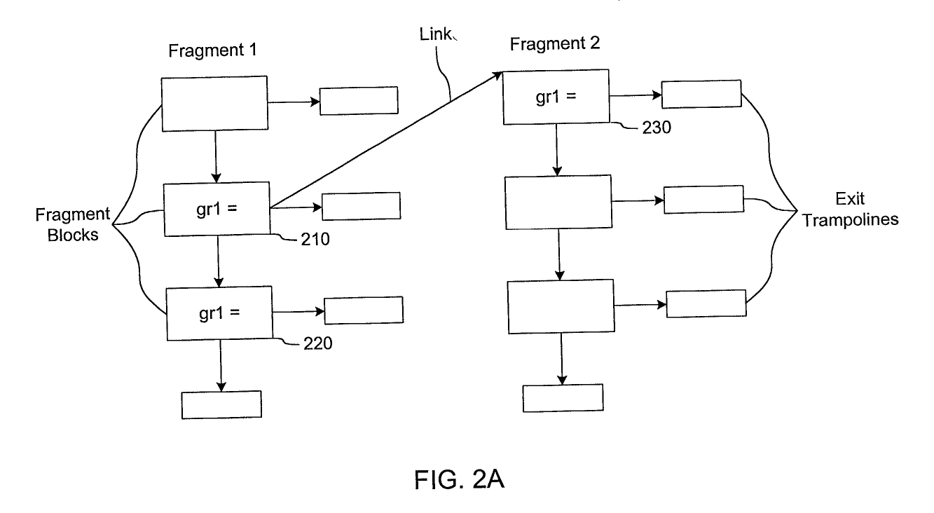

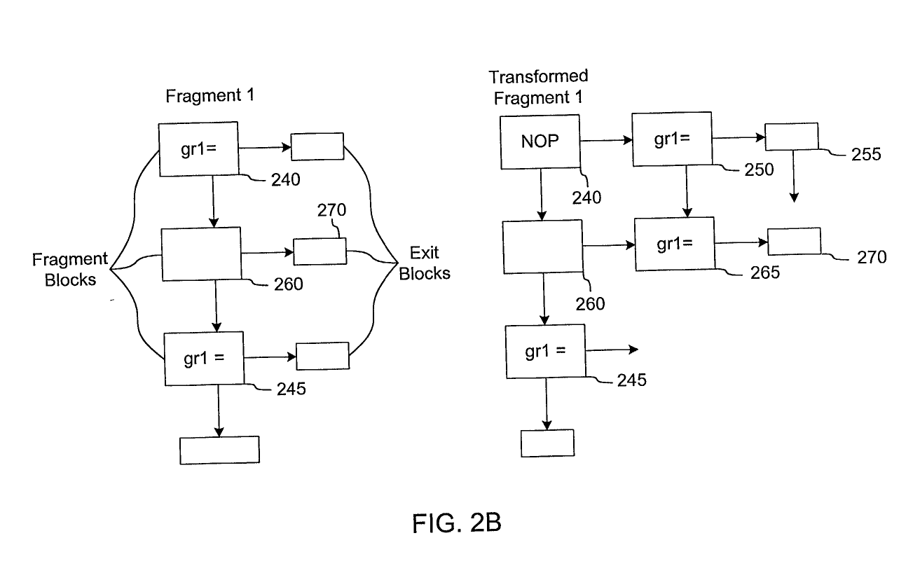

As discussed above, fragments stored in the code cache are single entry, multiple exit dynamic sequences of instructions. To minimize the amount of context switching that is necessary each time execution exits the code cache through a trampoline exit block, the fragments in the cache can be directly inter-linked. Exit branches from a fragment that target another fragment currently in the cache may be directly linked or “backpatched” to the other fragment, thereby bypassing the original trampoline block and expensive context switches. FIG. 2A shows how the exit branch at block 210 of fragment 1 is backpatched directly to target fragment 2.

One of the optimizations that is possible in the context of a caching dynamic translator with the trace optimizer 150 is the removal of dead code. In addition to removing dead code, the trace optimizer can identify and remove instructions that only become dead after linking between fragments. The process of removing dead code is discussed below.

The caching dynamic translator provides a context for identifying and removing dead code arising from the linking of fragments dynamically at run time. There are other contexts, however, where dead code arising from the linking of fragments may be removed. For example, dead code arising from the linking of fragments may be removed during the static linking of object code after compilation or at load time when a program is first initiated, or dynamically at run time, such as with a caching dynamic translator.

As discussed above, an instruction is called dead if it writes to a register and the register is re-assigned without being read prior to the next exit, whereas an instruction is called live if it assigns a register that is read subsequently. There are situations, however, where it is not possible to determine immediately whether an instruction is live or dead. These instructions, which may be referred to as being possibly live, arise in the following situations. First, a register assignment is possibly live if there are exits in the fragment before the register is reassigned and the register is not read before the reassignment. A register assignment is also possibly live if the register is never read subsequently in the fragment. Instructions that are possibly live are candidates for removal.

An instruction that is possibly live is dead across fragments if it is possibly live in one fragment but becomes dead after linking. FIG. 2A illustrates an example of dead code that arises only after linking. Fragment 1 contains an assignment to register gr1 in block 210 that is possibly live. Box 210 is possibly live because there is an exit before register gr1 is reassigned in box 220, and register gr1 is not read before being reassigned. Prior to linking the exit at box 210 with the entry at fragment 2, it is not known whether the value of gr1 is read after exiting from fragment 1 before being reassigned. After linking the exit at box 210 to fragment 2, it can be determined that the assignment in box 210 is indeed dead across fragment because gr1 is assigned in fragment 2 at box 230 without being read first.

As shown in FIG. 2A, register gr1 is reassigned in box 220 immediately after being assigned in box 210. To determine whether the assignment was dead across fragments, it was only necessary to look at fragment 2, which has the entry corresponding to the exit from box 210. Since register gr1 was assigned in box 230 before being read, it was determined that the assignment in box 210 was dead across fragments and could be overwritten with a no operation (NOP).

There may be situations, however, in which there are multiple exits between the original assignment to a register and a later reassignment without an intervening reading of the register. Similarly, there may be multiple exits after a register is assigned but never subsequently read in a fragment. Since there are multiple exits, the original assignment may be dead across the link to a fragment having an entry corresponding to one of the exits but not across the link to a different fragment having an entry corresponding to another one of the exits. Unless the original assignment is dead across the link to each fragment having an entry corresponding to one of the exits, the original assignment is not dead across all fragments and cannot be removed. Accordingly, the fragments having entries corresponding to each of the intervening exits must be analyzed to determine if the original assignment is dead across all fragments and may be removed.

FIG. 2B shows a block diagram of fragment 1 in which there are two exits between the original assignment in box 240 and the reassignment in box 245. Having determined that the assignment in box 240 is possibly live, but that there are multiple exits between box 240 and box 245, fragment 1 is transformed to facilitate the determination of whether the assignment in box 240 is dead across fragments. This transformation is referred to as code sinking.

As shown in the transformed fragment 1, the register assignment in box 240 is replaced with a NOP. In addition, a box 250, which includes the register assignment to register gr1, is added between box 240 and the exit box 255. A box 265, which includes the same assignment to register gr1, is also added between box 260 and exit box 270.

To determine if the assignment in box 250 is dead, the fragment having an entry corresponding to the exit at box 255 is analyzed to determine if register gr1 is assigned before being read. If so, then the assignment in box 250 can be removed and replaced with a NOP. If not, the assignment in box 250 remains. Similarly, to determine if the assignment in box 265 is dead, the fragment having an entry corresponding to box 270 is analyzed to determine if register gr1 is assigned before being read. If so, then the assignment in box 265 can be removed and replaced with a NOP. If not, the assignment in box 265 remains. By using code sinking, a possibly live assignment only remains at exits where the register is read before being assigned in the fragment corresponding to the exit.

It should be recognized that the code sinking process is not necessary to determine if an assignment is dead across multiple fragments. Instead of code sinking, it may be possible to check each of the multiple exits and only remove and replace the original assignment if the register is assigned before being read in each of the fragments corresponding to the exits.

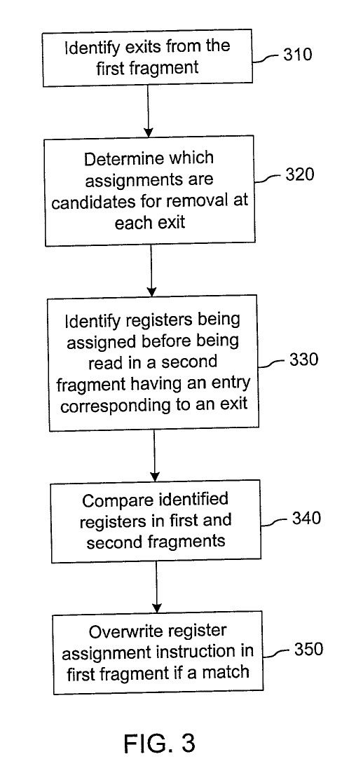

FIG. 3 is a flow diagram of a process for removing dead code between two linked fragments consistent with the present invention. As shown in FIG. 3, each of the exits in a first fragment is identified (step 310). For each exit, it is then determined which register assignments are candidates for removal (step 320). As discussed above, a candidate for removal corresponds to register assignments that are possibly live, i.e., register assignments that may be dead or alive depending upon the result after linking. To determine whether a register assignment is a candidate for removal, a data flow analysis, or more specifically, a live variable analysis may be performed. The live variable analysis identifies when and how a variable is used, identifies the location of exits in a fragment, and determines, based on this information, whether a register assignment is alive, dead or possibly live within a fragment. The live variable analysis can be performed at compile time or at run time.

It is possible that there are more than one candidate for removal at each exit. For example, an assignment to register gr1 that is possibly live may be followed by an assignment to register gr2 that is also possibly live. As a result, the assignments to registers gr1 and gr2 are both candidates for removal at the exit following the assignment to register gr2. A list of the registers corresponding to the candidates for removal may be maintained for each exit.

In addition to this analysis of the first fragment, an analysis is performed on a second fragment having an entry corresponding to an exit of the first fragment. For the second fragment, registers are identified which are assigned before being read in the fragment (step 330). These registers can be identified using the information identified by the live variable analysis, i.e., when and how a variable is used.

The identified registers in the second fragment are compared against the list of registers corresponding to the candidates for removal in the first fragment (step 340). If an identified register in the second fragment matches a register in the list of registers in the first fragment, the candidate for removal corresponding to the matched register is dead and may be eliminated (step 350). Elimination may be accomplished in various ways. The candidate for removal may be overwritten with a NOP. Alternatively, the candidate for removal may be eliminated by compacting the instructions around the removed instruction.

Each time a link is established between two fragments, information can be propagated across the new connection. One approach to exploit this additional information would be to re-generate and re-optimize the combined connected fragment. A less expensive approach is to apply peephole optimizations around the new connection. The goal of these optimizations is the removal of instructions that are dead across fragments, which could not have been eliminated prior to establishing the connection.

One way to detect these additional dead instructions after linking would be to completely re-analyze the combined code. It is preferable, however, to perform this link-time optimization without any form of re-analysis or decoding of the fragment code at link-time. Prior to link-time and during fragment generation, each fragment is analyzed and optimized in isolation. At this point, the information identified by the live variable analysis that is held at fragment entry and exit points is readily available, but it cannot be used since it is not yet known how the fragment entry and exit points are interconnected. Instead of discarding the unused information at fragment generation time and re-computing it later at link-time, the relevant information may be stored in a fixed-sized epilog at each fragment's exit point and in a fixed-size prolog at each entry point.

The epilog structure associated with each exit e is a size k array of pointers to instructions that represent the possibly live assignments that may become dead after linking. Not every assignment that is possibly live will be removed because a possibly live instruction that is dead across one exit is not necessarily dead across other exits. Possibly live assignments can only be removed at an exit if their becoming dead across that exit implies that they are dead along all paths through the fragment.

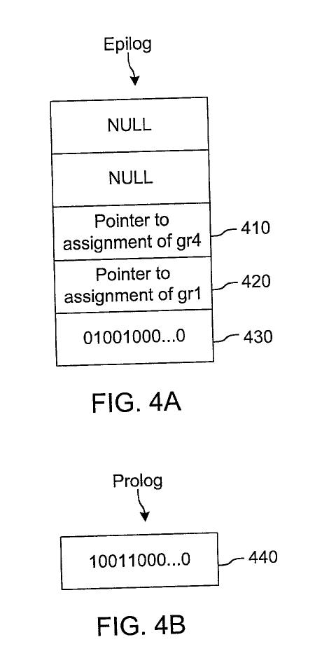

Up to (k−1) such candidates may be selected such that each candidate writes to exactly one register and at most one candidate writes to each register. The set of candidates may be sorted by increasing value of the register to which each candidate writes. A list of pointers to the actual code positions of the candidates, sorted by their position in the fragment, is stored in the epilog. FIG. 4A shows an example of an epilog for k=5, i.e., there is room for four instruction pointers in the epilog. In the example of FIG. 4A there are two pointers to candidates for removal: a pointer 410 to the assignment of register gr4 and a pointer 420 to the assignment of register gr1. The remaining unused pointers are set to NULL.

To quickly access the correct pointers at runtime, the k-th word in the epilog contains a register mask 430. Each bit position in the register mask 430 corresponds to a different one of the registers. For example, the bit at position i corresponds to register i, where the first bit position corresponds to register gr0, the second to register gr1, and so on. The bit at position i in the mask is set only if there exists a candidate that writes to register i. For example in FIG. 4A, where the first position in register mask 430 corresponds to the zero bit and register gr0, the first and fourth bits of register mask 430 are set, which correspond to assignments pointed to by pointers 410 and 420. Given a bit position i that is set in the register mask 430, it remains to find the correct pointer pointing to the candidate for removal corresponding to register i. Since the pointers have been sorted in increasing order, the register mask 430 also serves as a means to access the correct pointer. The correct pointer is found simply by counting the number of bits in the mask that are set prior to the bit position of interest. If there are j such bits, the (j+1)-th pointer is the one that points to the correct candidate. In the example of FIG. 4A, bit number 1 is the only bit set prior to bit position 4. Thus, the correct pointer to the assignment to register gr4 is the second pointer 420 as shown in FIG. 4A.

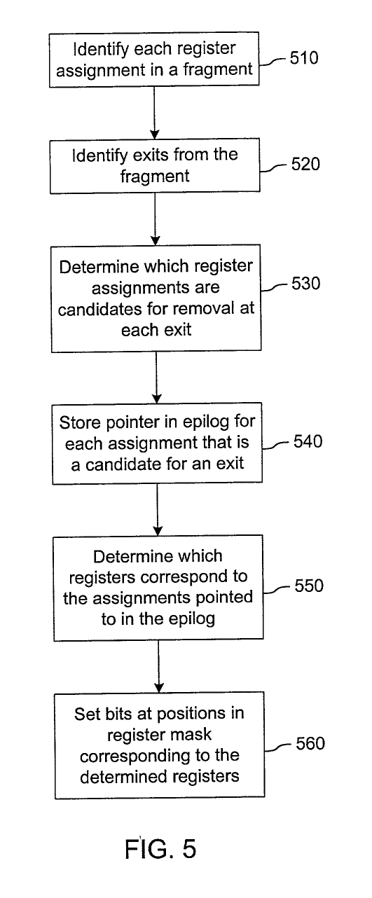

FIG. 5 is a flow diagram for generating an epilog consistent with the present invention. As shown in FIG. 5, the first step is to identify each register that is assigned in a fragment (step 510). In addition, each exit in the fragment is identified (step 520). Using this information, it is then determined which register assignments at each exit are candidates for removal (step 530). As discussed above, a register assignment is a candidate for removal if it is possibly live in the fragment, i.e., it may be dead or alive depending upon the result after linking. Each exit may identify no candidates, a single candidate or multiple candidates.

For each register assignment determined to be a candidate at an exit, a pointer is stored in the epilog for the exit (step 540). The pointers in the epilog are preferably stored in ascending order with respect to the number of the register being assigned by the candidate. For example, if the candidates are for register assignments to registers gr1 and gr2, the pointer for the candidate assigning register gr2 would be placed above the pointer to the candidate assigning register gr1.

In addition to storing the pointers to the candidates, it is determined which registers are being assigned by the candidates (step 550). The bits of the register mask of the epilog are set which correspond to the determined registers (step 560). For example, if the registers are determined to be gr0 and gr3, the first and fourth positions of the register mask would be set.

A prolog associated with each fragment entry contains a single word to store a register mask. An example of a prolog is shown in FIG. 4B. As shown in FIG. 4B, a register mask 440 indicates which registers are assigned in the fragment prior to being read. Like the register mask 430 in the epilog, each bit position in the register mask 440 corresponds to a different one of the registers. For example, the bit at position i corresponds to register i, where the first bit position corresponds to register gr0, the second to register gr1, and so on. Bit i in the mask is set if register i is assigned before being read. In the example of FIG. 4B, the prolog indicates that registers gr0, gr3 and gr4 are assigned prior to being read.

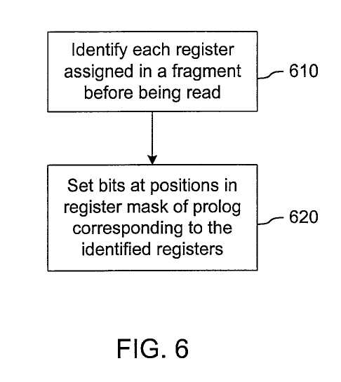

FIG. 6 is a flow diagram for generating a prolog consistent with the present invention. As shown in FIG. 6, the first step is to identify each register in a fragment which is assigned before being read (step 610). Unlike the epilog, there is no need to store pointers to these register assignments. The bits of the register mask of the prolog are set at positions corresponding to the identified registers (step 620). For example, if the registers are identified as gr0 and gr3, the first and fourth positions of the register mask would be set.

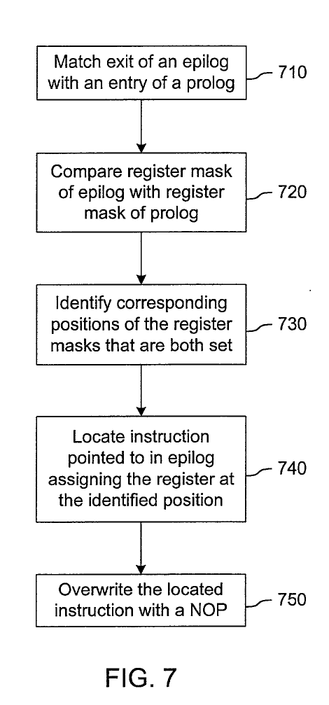

Based on the information stored in the epilog and prolog, dead code may be removed when linking a fragment exit and fragment entry. FIG. 7 is a flow diagram for removing dead code based on an epilog and a prolog consistent with the present invention. As shown in FIG. 7, the first step is to match the exit corresponding to an epilog with the entry corresponding to a prolog (step 710). The register mask of the epilog is then compared to the register mask of the prolog (step 720). Based on the comparison, corresponding positions of the register masks that are both set are identified (step 730). These positions may be identified by effecting the logical conjunction of the register masks of the matched epilog and prolog using, for example, AND logic. The bits that are set in the result vector of the logical conjunction indicate the register assignments that are dead across the fragments linked by the matched exit and entry point.

The next step is to locate the dead instructions by accessing the correct pointer in the epilog (step 740). As discussed above, the proper pointer can be located by counting the number of set bits from left to right, where the pointers in the epilog are stored in ascending order according to the number of the register being assigned by the candidate. Then, using the pointer of the reference, the located instruction is removed and overwritten with a NOP (step 750). Based on the epilog and prolog, it can be determined which instructions are dead across the fragments linked by the exit and entry corresponding to the epilog and prolog. Using the process of FIG. 7, up to (k−1) dead instructions may be removed each time an exit branch is linked to a fragment entry.

Using the process described in FIGS. 7-9 avoids any form of analysis or instruction decoding at link-time when the optimization is performed. Analysis is avoided by setting up the complete machinery to perform the optimization prior to link time when the fragment code is generated and the necessary data flow information is available from local fragment analysis. Using this scheme there is no redundant reanalysis at link-time and actually performing the optimization has only constant time overhead. If dead code removal is performed across link interfaces, it can be expected that dead code removal is also performed earlier within each fragment. If that is the case, the information about possibly live assignments that is stored in the epilog and prologs is readily available as part of the results of fragment analysis. Thus, no additional analysis is necessary to enable cross fragment optimization. Except for the overhead of storing epilogs and prologs, dead code removal across fragments is achieved essentially for free.

The above disclosure describes an epilog-prolog scheme for dead code removal during linking of fragments. The fragments may be fragments stored in a dynamic caching translator. In this instance, the dead code removal is done during the linking of fragments at runtime. The dead code removal with appropriate adjustments may also be applied to extend to other optimizations at link-time, such as register allocation.

The foregoing description of a preferred embodiment of the invention has been presented for purposes of illustration and description. It is not intended to be exhaustive or to limit the invention to the precise form disclosed, and modifications and variations are possible in light in the above teachings or may be acquired from practice of the invention. The embodiment was chosen and described in order to explain the principles of the invention and as practical application to enable one skilled in the art to utilize the invention in various embodiments and with various modifications are suited to the particular use contemplated. It is intended that the scope of the invention be defined by the claims appended hereto and their equivalents.

What is claimed is:

1. A method for removing dead code in code fragments of a program, comprising:
processing a first code fragment and storing first information generated during this processing indicative of whether an instruction for assigning a register in a first code fragment is possibly live;
processing a second code fragment and storing second information generated during this processing indicative of register usage;
at a time when the first and second code fragments are to be linked, determining, by use of the first and second stored information, if an instruction in the first code fragment that assigns a register is a dead instruction; and
responsive to determination that an instruction is a dead instruction, eliminating the dead instruction.

2. A method according to claim 1, wherein eliminating the dead instruction comprises overwriting the dead instruction with a NOP.

3. A method according to claim 1, wherein eliminating the dead instruction comprises compacting the surrounding instructions to delete the dead instruction.

4. A method according to claim 1, wherein:
the first information includes information associated with each exit from the first code fragment;
the second information includes information associated with each entry into the second code fragment;
the linking of the first and second code fragments links a particular exit from the first code fragment to a particular entry into the second code fragment;
the step of determining uses the first information associated with the particular exit and the second information associated with the particular entry.

5. A method according to claim 4, wherein the first information associated with each exit includes a pointer to each instruction for assigning a register that is possibly live for that exit.

6. A method according to claim 5, wherein the first information associated with each exit further includes a first register mask, the first register mask having a plurality of positions, each position corresponding to a respective register, wherein a bit at a position is set if the respective register is assigned in an instruction pointed to by a pointer in the first information associated with that exit.

7. A method according to claim 6, wherein the second information associated with each entry includes a second register mask, the second register mask having a plurality of positions, each position corresponding to a respective register, wherein a bit at a position is set if the respective register is assigned in the second fragment before being read.

8. A method according to claim 7, where said determining step comprises comparing corresponding positions of the first and second register masks, wherein said eliminating step includes eliminating an instruction for assigning a register in the first code fragment if the positions corresponding to the register in the first and second register masks are both set.

9. A method according to claim 8, wherein said eliminating step further comprises determining which instruction to overwrite with reference to the pointers in first information.

10. A method according to claim 4, wherein the first information associated with each exit is stored in an epilog associated with that exit, and the second information associated with each entry is stored in a prolog associated with that entry.

11. A computer readable comprising instructions for removing dead code in code fragments of a program, the instructions configured to:
process a first code fragment and store first information generated during this processing indicative of whether an instruction for assigning a register in a first code fragment is possibly live;
process a second code fragment and store second information generated during this processing indicative of register usage;
at a time when the first and second code fragments are to be linked, determine, by use of the first and second stored information, if an instruction in the first code fragment that assigns a register is a dead instruction; and
responsive to determination that an instruction is a dead instruction, eliminate the dead instruction.

12. A computer readable medium according to claim 11, wherein eliminating the dead instruction comprises overwriting the dead instruction with a NOP.

13. A computer readable medium according to claim 11, wherein eliminating the dead instruction comprises compacting the surrounding instructions to delete the dead instruction.

14. A computer readable medium according to claim 11 wherein:
the first information includes information associated with each exit from the first code fragment;
the second information includes information associated with each entry into the second code fragment;
the linking of the first and second code fragments links a particular exit from the first code fragment to a particular entry into the second code fragment;
the step of determining uses the first information associated with the particular exit and the second information associated with the particular entry.

15. A computer readable medium according to claim 14, wherein the first information associated with each exit includes a pointer to each instruction for assigning a register that is possibly live for that exit.

16. A computer readable medium according to claim 15, wherein the first information associated with each exit further includes a first register mask, the first register mask having a plurality of positions, each position corresponding to a respective register, wherein a bit at a position is set if the respective register is assigned in an instruction pointed to by a pointer in the first information associated with that exit.

17. A computer readable medium according to claim 16, wherein the second information associated with each entry includes a second register mask, the second register mask having a plurality of positions, each position corresponding to a respective register, wherein a bit at a position is set if the respective register is assigned in the second fragment before being read.

18. A computer readable medium according to claim 17, where said determining step comprises comparing corresponding positions of the first and second register masks, wherein said eliminating step includes eliminating an instruction for assigning a register in the first code fragment if the positions corresponding to the register in the first and second register masks are both set.

19. A computer readable medium according to claim 18, wherein said eliminating step further comprises determining which instruction to overwrite with reference to the pointers in first information.

20. A computer readable medium according to claim 14, wherein the first information associated with each exit is stored in an epilog associated with that exit, and the second information associated with each entry is stored in a prolog associated with that entry.
